(19) United States
(12) Patent Application Publication
(10) Pub. No.: US 2015/0085648 A1
(43) Pub. Date: Mar. 26, 2015

(54) CONGESTION CONTROL IN DATA NETWORKS

(71) Applicant: Douglas Leith, Maynooth (IE)

(72) Inventor: Douglas Leith, Maynooth (IE)

(21) Appl. No.: 14/035,228

(22) Filed: Sep. 24, 2013

(51) Int. Cl. H04L 12/801

(52) U.S. Cl. CPC H04L 47/12
USPC 370/230

(57) ABSTRACT

A method of modifying transmission of packets over a network path comprises operating a processor to: transmit packets over the network path; determine, based on a number of unacknowledged packets transmitted over the network path, whether a congestion event has occurred, wherein an unacknowledged packet is a transmitted packet for which no acknowledgement has been received; and responsive to detecting a congestion event, operating a processor to modify the number of unacknowledged packets transmitted by a multiplicative factor βᵢ, wherein the multiplicative factor βᵢ is proportional to a ratio of a first time value to a second time value, the first time value being indicative of a minimum time required for a packet to be transmitted over the network path and the second time value being indicative of a current time required for a packet to be transmitted over the network path.

### BACKGROUND TO THE INVENTION

1. Field of the Invention

This invention relates to congestion control in data networks. It has particular but not exclusive application to networks upon which data is communicated using a transport layer protocol that is a modification of and is compatible with the standard transmission control protocol (TCP).

A problem in the design of networks is the development of congestion control algorithms. Congestion control algorithms are deployed for two principal reasons: to ensure avoidance of network congestion collapse, and to ensure a degree of network fairness. Put simply, network fairness refers to the situation whereby a data source (transmitter or sender) receives a fair share of available bandwidth, whereas congestion collapse refers to the situation whereby an increase in network load results in a decrease of useful work done by the network (usually due to retransmission of data).

Note that in this context “fairness” of access to a network does not necessarily mean equality of access. Instead, it means a level of access appropriate to the device in question. Therefore, it may be deemed fair to provide a high-speed device with a greater level of access to a channel than a slow channel because this will make better use of the capacity of the channel.

2. Background

Congestion control is used in modern communication networks to (i) roughly match the send rate to the available network capacity and (ii) provide a degree of fairness between flows sharing the same link. The standard Additive Increase Multiplicative Decrease (AIMD) congestion control algorithm used in TCP was designed for links where packet loss occurs primarily due to queue overflows, and so uses packet loss an indicator of network congestion. However on modern communication links, particularly wireless links, significant packet loss also occurs for reasons not related to congestion. The standard TCP congestion control algorithm performs poorly on such links since it responds to loss by reducing the send rate. Whilst this action is correct when loss is due to queue overflows, it is incorrect when loss is not related to congestion and can lead to poor utilisation of the available network capacity. Accordingly, new congestion control algorithms must be developed to accompany the development of networking systems.

The task of developing such algorithms is not straightforward. In addition to the requirements discussed above, fundamental requirements of congestion control algorithms include efficient use of bandwidth, fair allocation of bandwidth among sources and that the network should be responsive rapidly to reallocate bandwidth as required. These requirements must be met while respecting key constraints including decentralized design (TCP sources have restricted information available to them), scalability (the qualitative properties of networks employing congestion control algorithms should be independent of the size of the network and of a wide variety of network conditions) and suitable backward compatibility with conventional TCP sources.

To place the invention in context, a known TCP network model will now be described. The TCP standard defines a variable cwnd that is called the “congestion window”. This variable determines the number of unacknowledged packets that can be in transit at any time; that is, the number of packets in the ‘pipe’ formed by the links and buffers in a transmission path. When the window size is exhausted, the source must wait for an acknowledgement (ACK) before sending a new packet. Congestion control is achieved by dynamically varying cwnd according to an additive-increase multiplicative-decrease (AIMD) law. The aim is for a source to probe the network gently for spare capacity and back-off its send rate rapidly when congestion is detected. A cycle that involves an increase and a subsequent back-off is termed a “congestion epoch”. The second part is referred to as the “recovery phase”.

In the congestion-avoidance phase, when a source i receives an ACK packet, it increments its window size cwndᵢ according to the additive increase law:

cwndᵢ→cwndᵢ+αᵢ/cwndᵢ (1)

where αᵢ=1 for standard TCP. Consequently, the source gradually ramps up its congestion window as the number of packets successfully transmitted grows. By keeping track of the ACK packets received, the source can infer when packets have been lost en route to the destination. Upon detecting such a loss, the source enters the fast recovery phase. The lost packets are retransmitted and the window size cwndᵢ of source i is reduced according to:

cwndᵢ→βᵢcwndᵢ, (2)

where βᵢ=0.5 for standard TCP. It is assumed that multiple drops within a single round-trip time lead to a single back-off action. When receipt of the retransmitted lost packets is eventually confirmed by the destination, the source re-enters the congestion avoidance phase, adjusting its window size according to equation (1). In summary, on detecting a dropped packet (which the algorithm assumes is an indication of congestion on the network), the TCP source reduces its send rate. It then begins to gradually increase the send rate again, probing for available bandwidth. A typical window evolution is depicted in FIG. 1 (cwndᵢ at the time of detecting congestion is denoted by wᵢ in FIG. 1).

Over the kth congestion epoch three important events can be discerned from FIG. 1. (A congestion epoch is defined here as a sequence of additive increases ending with one multiplicative decrease of cwnd.) These are indicated by tₐ(k); t_{b}(k) and t_{c}(k) in FIG. 1. The time tₐ(k) is the time at which the number of unacknowledged packets in the pipe equals βᵢwᵢ(k). t_{b}(k) is the time at which the pipe is full so that any packets subsequently added will be dropped at the congested queue. t_{c}(k) is the time at which packet drop is detected by the sources. Time is measured in units of round-trip time (RTT). RTT is the time taken between a source sending a packet and receiving the corresponding acknowledgement, assuming no packet drop. Equation 1 corresponds to an increase in cwndᵢ of αᵢ packets per RTT.

### SUMMARY OF THE INVENTION

Embodiments of the invention provide a congestion control algorithm suited to lossy links and which are able to make much better use of the available capacity. Importantly, this is achieved while (i) maintaining backward compatibility with standard TCP on traditional links (where losses are primarily due to queue overflow), (ii) not making matters significantly worse for standard TCP on lossy links and (iii) providing similar throughput fairness amongst flows sharing a link as does standard TCP.

Furthermore, embodiments of the invention provide a means for recovering erased (dropped or lost) information packets at a receiver, without requiring re-transmission of these packets.

In a first aspect of the invention, there is provided a method of modifying transmission of packets over a network path, the method comprising operating a processor to: transmit packets over the network path; determine, based on a number of unacknowledged packets transmitted over the network path, whether a congestion event has occurred, wherein an unacknowledged packet is a transmitted packet for which no acknowledgement has been received; and responsive to detecting a congestion event, operating a processor to modify the number of unacknowledged packets transmitted by a multiplicative factor βᵢ, wherein the multiplicative factor is proportional to a ratio of a first time value to a second time value, the first time value being indicative of a minimum time required for a packet to be transmitted over the network path and the second time value being indicative of a current time required for a packet to be transmitted over the network path. In this manner, the rate of transmission of packets is reduced (or backs off) in accordance with the multiplicative factor βᵢ which is advantageously determined so that the rate of transmission is not decreased on packet loss unless the network is congested.

Responsive to determining that a congestion event has not occurred, the method may further comprise operating a processor to: modify the number of unacknowledged packets transmitted over the network path by an additive factor αᵢ.

Responsive to determining that a congestion event has not occurred, the method further comprises operating a processor to determine an elapsed period of time since detection of a congestion event. The processor may additionally be operated to determine the additive factor αᵢ in accordance with the elapsed period of time since detection of a congestion event. For example, when the elapsed period of time since detection of a congestion event is less than a threshold value, the additive factor αᵢ is equal to unity.

The processor may be operated to determine the additive factor αᵢ in accordance with the elapsed period of time since detection of a congestion event may comprise operating the processor to increase the additive factor αᵢ as a function of the congestion epoch timer.

Additionally or alternatively, the processor may be operated to determine the additive factor αᵢ in accordance with the elapsed period of time since detection of a congestion event comprises operating the processor to increase the additive factor αᵢ at intervals during a period in which the congestion epoch timer is greater than a threshold value.

The processor may be operated to detect a congestion event if one or more of: (i) a packet loss is detected; and (ii) an estimated time for a packet to be transmitted over the network path is greater than a predefined threshold value.

In some embodiments, the method may further comprise operating a processor to: estimate, at predefined intervals, a round-trip delay between a time of transmitting a packet over the network path and a time of receiving an acknowledgement that the packet has been received; and set the second time value to the estimated round-trip delay.

The first time value may be an estimate of a minimum round-trip delay between a time of transmitting a packet over the network path and a time of receiving an acknowledgement that the packet has been received. In this case, the multiplicative factor βᵢ is equal to a ratio of the first time value to the second time value.

In some embodiments, the method may comprise operating a processor to: estimate, at predefined intervals, a one-way delay time between a time at which the packet is transmitted over the network path and a time at which the packet is received by a receiver; and set the second time value to the estimated one-way delay time.

The first time value may be an estimate of a minimum one-way delay time between a time at which a packet is transmitted over the network path and a time at which the packet is received by a receiver; and the multiplicative factor βᵢ may be equal to a ratio of the first time value to the second time value.

In some embodiments, the second value is an exponentially weighted moving average of estimated packet delays.

The network over which the packets are transmitted may be a wireless network. Embodiments of the invention may be implemented as part of one or more of: a transport layer protocol; a network tunnel protocol; and a network proxy protocol.

In embodiments of the invention, operating a processor to transmit packets over the network path comprises operating the processor to: encode the packets using error correction coding; and transmit the encoded packets. Operating a processor to encode the packets using error coding and to transmit the encoded packets may, for example, comprise operating the processor to: transmit a predetermined number of information packets; generate an encoded packet based on the predetermined number of information packets; and transmit the encoded packet.

The processor may be operated to generate the encoded packet using Reed-Solomon encoding. Additionally or alternatively, the processor may be operated to generate the encoded packet using linear encoding.

The method may further comprise operating a processor located at (or comprised within or operated by) a receiver to: receive the encoded packets; and decode the received packets using Gaussian elimination decoding.

In accordance with a further aspect of the invention, there is provided a method of transmitting packets over a network path, the method comprising operating a processor to: transmit a plurality of packets over the network path; responsive to detecting that a congestion event has occurred, to modify a rate of packet transmission by a multiplicative factor βᵢ, wherein βᵢ is proportional to a ratio of a first time value to a second time value, wherein the first time value is indicative of a minimum time RTTmin for a packet to be transmitted over the network and the second time value is indicative of a current time RTT for a packet to be transmitted over the network; and transmit a plurality of packets in accordance with the modified rate of packet transmission.

In accordance with a further aspect of the invention, there is provided an integrated circuit comprising electronic components configured to: transmit packets over the network path; determine, based on a number of unacknowledged packets transmitted over the network path, whether a congestion event has occurred, wherein an unacknowledged packet is a transmitted packet for which no acknowledgement has been received; and responsive to detecting a congestion event, operating a processor to modify the number of unacknowledged packets transmitted by a multiplicative factor βᵢ, wherein the multiplicative factor βᵢ is proportional to a ratio of a first time value to a second time value, the first time value being indicative of a minimum time required for a packet to be transmitted over the network path and the second time value being indicative of a current time required for a packet to be transmitted over the network path.

In accordance with a further aspect of the invention, there is provided a processor comprising circuitry configured to: transmit packets over the network path; determine, based on a number of unacknowledged packets transmitted over the network path, whether a congestion event has occurred, wherein an unacknowledged packet is a transmitted packet for which no acknowledgement has been received; and responsive to detecting a congestion event, operating a processor to modify the number of unacknowledged packets transmitted by a multiplicative factor βᵢ, wherein the multiplicative factor βᵢ is proportional to a ratio of a first time value to a second time value, the first time value being indicative of a minimum time required for a packet to be transmitted over the network path and the second time value being indicative of a current time required for a packet to be transmitted over the network path.

In accordance with a further aspect of the invention, there is provided a transmitter for sending packets over a network path, wherein the transmitter comprises processing circuitry configured to: transmit packets over the network path; determine, based on a number of unacknowledged packets transmitted over the network path, whether a congestion event has occurred, wherein an unacknowledged packet is a transmitted packet for which no acknowledgement has been received; and responsive to detecting a congestion event, operating a processor to modify the number of unacknowledged packets transmitted by a multiplicative factor βᵢ, wherein the multiplicative factor βᵢ is proportional to a ratio of a first time value to a second time value, the first time value being indicative of a minimum time required for a packet to be transmitted over the network path and the second time value being indicative of a current time required for a packet to be transmitted over the network path.

The processing circuitry of the transmitter may be configured to detect a congestion event if one or more of: (i) a packet loss is detected; and (ii) an estimated time for a packet to be transmitted over the network path is greater than a predefined threshold value.

The processing circuitry may be further configured to: estimate, at predefined intervals, a round-trip delay between a time of transmitting a packet over the network path and a time of receiving an acknowledgement that the packet has been received; and set the second time value to the estimated round-trip delay. In some embodiments the first time value may be an estimate of a minimum round-trip delay between a time of transmitting a packet over the network path and a time of receiving an acknowledgement that the packet has been received and the processing circuitry may be configured to determine the multiplicative factor βᵢ to be equal to a ratio of the first time value to the second time value.

In embodiments of the invention, the processing circuitry may be further configured to estimate, at predefined intervals, a one-way delay time between a time at which the packet is transmitted over the network path and a time at which the packet is received by a receiver; and set the second time value to the estimated one-way delay time. In some embodiments, the first time value may be an estimate of a minimum one-way delay time between a time at which a packet is transmitted over the network path and a time at which the packet is received by a receiver; and the processing circuitry may be configured to determine the multiplicative factor βᵢ to be equal to a ratio of the first time value to the second time value.

In some embodiments, the processing circuitry of the transmitter may be configured such that transmitting packets over the network path comprises: encoding the packets using error correction coding; and transmitting the encoded packets. For example, the processing circuitry may be configured such that encoding the packets using error coding and transmitting the encoded packets comprises: transmitting a predetermined number of information packets; generating an encoded packet based on the predetermined number of information packets; and transmitting the encoded packet.

The processing circuitry may be configured to generate the encoded packet using Reed-Solomon encoding. Additionally or alternatively, the processing circuitry is configured to generate the encoded packet using linear encoding.

In a further aspect of the invention, there is provided a system comprising a transmitter for sending data packets over a network path and a receiver for receiving the data packets sent by the transmitter, wherein the transmitter comprises processing circuitry configured to: transmit packets over the network path; determine, based on a number of unacknowledged packets transmitted over the network path, whether a congestion event has occurred, wherein an unacknowledged packet is a transmitted packet for which no acknowledgement has been received; and responsive to detecting a congestion event, operating a processor to modify the number of unacknowledged packets transmitted by a multiplicative factor βi, wherein the multiplicative factor βi is proportional to a ratio of a first time value to a second time value, the first time value being indicative of a minimum time required for a packet to be transmitted over the network path and the second time value being indicative of a current time required for a packet to be transmitted over the network path.

In a further aspect of the invention, there is provided a non-transitory computer-readable medium comprising instructions which when executed cause a processor to: transmit packets over the network path; determine, based on a number of unacknowledged packets transmitted over the network path, whether a congestion event has occurred, wherein an unacknowledged packet is a transmitted packet for which no acknowledgement has been received; and responsive to detecting a congestion event, operating a processor to modify the number of unacknowledged packets transmitted by a multiplicative factor βᵢ, wherein the multiplicative factor βᵢ is proportional to a ratio of a first time value to a second time value, the first time value being indicative of a minimum time required for a packet to be transmitted over the network path and the second time value being indicative of a current time required for a packet to be transmitted over the network path.

### BRIEF DESCRIPTION OF THE DRAWINGS

In the drawings:

FIG. 1 is a graph illustrating the evolution of the congestion window (cwindᵢ) in conventional TCP, and has already been discussed;

FIG. 2 is a graph illustrating the evolution of the congestion window (cwindᵢ) for two flows in which the flows have unequal increase and decrease parameters αᵢ, βᵢ which satisfy the relation αᵢ=2(1−βᵢ);

FIG. 3 is a graph illustrating the evolution of the congestion window (cwindᵢ) using an adapted TCP;

FIG. 4 is a graph illustrating the evolution of the congestion window (cwindᵢ) for two flows in a high-speed link using an adapted TCP;

FIG. 5 is a graph illustrating the evolution of the congestion window (cwindᵢ) for two flows in a low-speed link using an adapted TCP; and

FIG. 6 is a block diagram of an adaptive congestion and control scheme embodying the invention.

FIG. 7 is a flow diagram of a method according to an embodiment of the invention.

FIGS. 8a and 8b are flow diagrams depicting methods according to an embodiment of the invention.

FIG. 9 is a flow diagram of a method according to an embodiment of the invention.

FIG. 10 is a flow diagram of a method according to an embodiment of the invention.

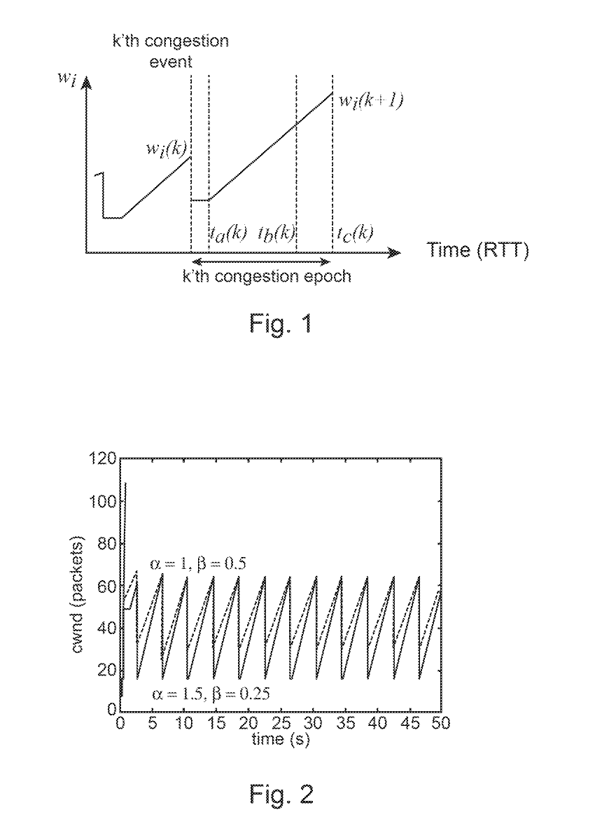

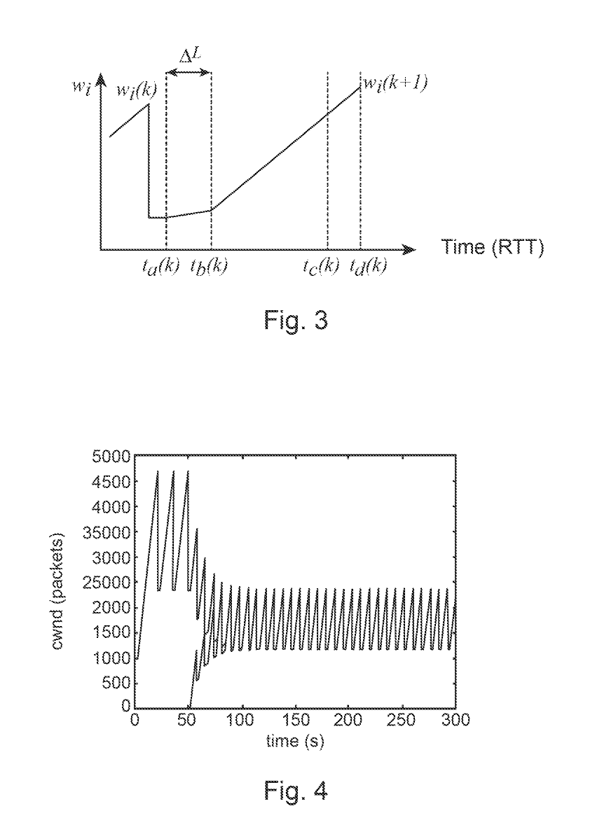

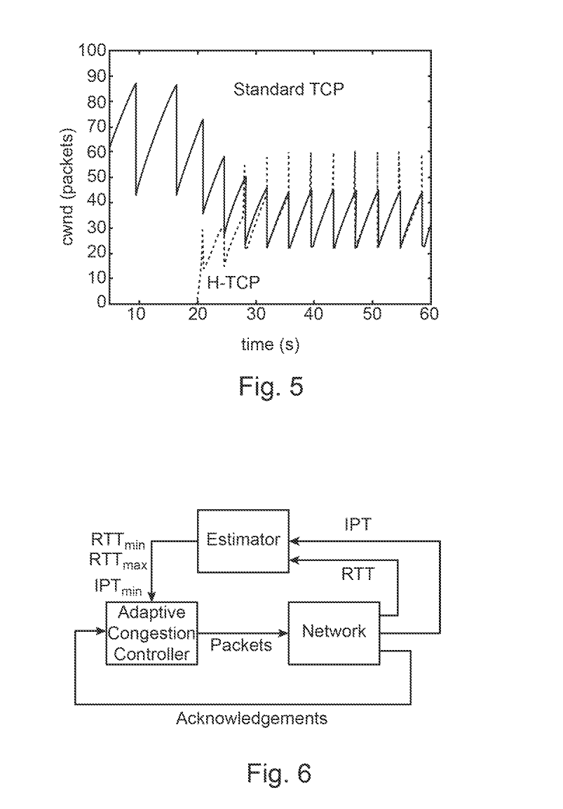

### DETAILED DESCRIPTION

### Adapted TCP

A note on the issue of network convergence and fair allocation of network bandwidth will now be presented in order that the workings of the present invention can be better understood.

Let αᵢ=λ(1−βᵢ)∀i and for some λ>0. Then Wₛₛ^{T}=Θ/n[1, 1, . . . , 1]; that is w₁=w₂= . . . =wₙ, where n is the number of network sources. For networks where the queuing delay is small relative to the propagation delay, the send rate is essentially proportional to the window size. In this case, it can be seen that αᵢ=λ(1−βᵢ)∀iε{1, . . . , n} is a condition for a fair allocation of network bandwidth. For the standard TCP choices of αᵢ=1 and βᵢ=0.5, we have λ=2 and the condition for other AIMD flows to co-exist fairly with TCP is that they satisfy αᵢ=2(1−βᵢ); see FIG. 2 for an example of the co-existence of two TCP sources with different increase and decrease parameters. (NS simulation, network parameters: 10 Mb bottleneck link, 100 ms delay, queue 40 packets). The network convergence, measured in number of congestion epochs, depends on the values of βᵢ.

Improvements in performance can be achieved by adapting the standard TCP as described in U.S. Pat. No. 7,394,762, the contents of which are incorporated by reference herein. This adapted TCP scheme will be described with reference to the accompanying drawings 1 to 6 and by way of providing a background information relating to embodiments of the invention.

to include a high-speed mode and a low-speed mode. In the high-speed mode, the increase parameter of source i is αᵢ^{H} and in the low-speed mode αᵢ^{L}. Upon congestion, the protocol backs off to βᵢwᵢ(k)−δᵢ, with δᵢ=0 in low-speed mode and δᵢ=βᵢ(αᵢ^{H}−αᵢ^{L}) in high-speed mode. This ensures that the combined initial window size

$${\sum }_{i = 1}^{n} ( {βw}_{i} ( k ) - {δ}_{i} )$$

following a congestion event is the same regardless of the source modes before congestion.

The mode switch is governed by

$${α}_{i} = \{ \begin{matrix}{α}_{i}^{L} {cwnd}_{i} - ( {β}_{i} {w}_{ι} ( k ) - {δ}_{i} ) \leq {Δ}^{L} \\ {α}_{i}^{H} {cwnd}_{i} - ( {β}_{i} {w}_{ι} ( k ) - {δ}_{i} ) > {Δ}^{L}\end{matrix} \qquad ( 3 )$$

where cwndᵢ is the current congestion window size of the ith TCP source βᵢwᵢ(k)−δᵢ, is the size of the congestion window immediately after the last congestion event, αᵢ^{L} is the increase parameter for the low-speed regime (unity for backward compatibility), αᵢ^{H} is the increase parameter for the high-speed regime, βᵢ is the decrease parameter as in conventional TCP, and Δ^{L} is the threshold for switching from the low to high speed regimes. This strategy is referred to as H-TCP and a typical congestion epoch is illustrated in FIG. 2.

It should be noted in the scheme for high-speed networks a mode switch takes place in every congestion epoch. Moreover, the strategy (4) leads to a symmetric network; that is, one where the effective αᵢ and βᵢ are the same for all H-TCP sources experiencing the same duration of congestion epoch.

The strategy is motivated by and realises several design criteria as will now be described.
Sources deploying H-TCP should behave as a normal TCP-source when operating on low-speed communication links. Such behaviour is guaranteed by (4) since the protocol tests the low-speed or high-speed status of the network every congestion epoch.
Normal AIMD sources competing for bandwidth should be guaranteed some (small) share of the available bandwidth.
H-TCP sources competing against each other should receive a fair share of the bandwidth. This is guaranteed using the symmetry arguments presented above.
H-TCP sources should be responsive. Again, this is guaranteed using symmetry and an appropriate value of combined with a value of αᵢ that ensures that the congestion epochs are of suitably short duration.

Embodiments of the invention can be developed further in various ways.

First, the strategy can be developed to include several mode switches.

The threshold Δ^{L} may be adjusted to reflect the absolute time in seconds since the last congestion event, or the number of RTTs since the last congestion event (RTT being the round-trip time, as described above).

During the high-speed mode, αᵢ may be adjusted in a continuous rather than switched manner. In particular, αᵢ may be varied as a polynomial function of RTT or elapsed time since last congestion event. For example, in accordance with:

$${α}_{i}^{H} = 1 + 10 ( {Δ}_{i} - {Δ}^{L} ) + {( \frac{{Δ}_{i} - {Δ}^{L}}{2} )}^{2} , \qquad ( 4 )$$

where Δ is elapsed time in seconds or RTTs since the last congestion event. Note that when a continuous update law is used it is possible to set δᵢ=0 in the high-speed mode.

Note that in all of the above cases, the convergence and fairness results of the first-described embodiment apply directly.

The performance of this high-speed algorithm is illustrated in FIG. 4 using an NS packet-level simulation. Two high-speed flows with the same increase and decrease parameters are shown. As expected, the stationary solution is fair. It can be seen that convergence is rapid, taking approximately four congestion epochs which is in agreement with the rise time analysis for βᵢ=0.5.

An important consideration in the design of embodiments of the invention is backward compatibility. That is, when deployed in low-speed networks, H-TCP sources should co-exist fairly with sources deploying standard TCP (α=1; β=0.5). This requirement introduces the constraint that αᵢ^{L}=1; βᵢ=0.5. When the duration of the congestion epochs is less than Δ^{L}, the effective increase parameter for high-speed sources is unity and the fixed point is fair when a mixture of standard and high-speed flows co-exist. When the duration of the congestion epochs exceeds Δ^{L}, the network stationary point may be unfair. The degree of unfairness depends on the amounts by which the congestion epochs exceed Δ^{L}, with a gradual degradation of network fairness as the congestion epoch increases. An example of this is illustrated in FIG. 4.

In this example, two H-TCP flows show rapid convergence to fairness. The second flow experiences a drop early in slow-start, focusing attention on the responsiveness of the congestion avoidance algorithm (NS simulation, network parameters: 500 Mb bottleneck link, 100 ms delay, queue 500 packets; TCP parameters: αⁱ=1; α^{H}=20; βᵢ=0.5; Δ^{L}=19 corresponding to a window size threshold of 38 packets).

As has been discussed, in standard TCP congestion control the AIMD parameters are set as follows: αᵢ=1 and βᵢ=0:5. These choices are reasonable when the maximum queue size in the bottleneck buffer is equal to the delay-bandwidth product, and backing off by a half should allow the buffer to just empty. However, it is generally impractical to provision a network in this way when, for example, each flow sharing a common bottleneck link has a different round-trip time. Moreover, in high-speed networks, large high-speed buffers are problematic for technical and cost reasons. The solution is an adaptive backoff mechanism that exploits the following observation.

At congestion the network bottleneck is operating at link capacity and the total data throughput through the link is given by:

$${R ( k )}^{-} = \frac{{\sum }_{i}^{n} {w}_{i} ( k )}{{RTT}_{ma x , i}} = \frac{{\sum }_{i}^{n} {w}_{i} ( k )}{{T}_{di} + \frac{{q}_{ma x}}{B}} , \qquad ( 5 )$$

where B is the link capacity, n is the number of network sources, qₘₐₓ is the bottleneck buffer size and where T_{di} is a fixed delay. After backoff, the data throughput through the link is given by:

$${R ( k )}^{+} = \frac{{\sum }_{i}^{n} {β}_{i} {w}_{i} ( k )}{{RTT}_{m i n , i}} = \frac{{\sum }_{i}^{n} {β}_{i} {w}_{i} ( k )}{{T}_{{d}_{i}}} , \qquad ( 6 )$$

under the assumption that the bottleneck buffer empties. Clearly, if the sources backoff too much, data throughput will suffer. A simple method to ensure maximum throughput is to equate both rates yielding the following (non-unique) choice of βᵢ:

$${β}_{i} = \frac{{T}_{di}}{{T}_{di} + \frac{{q}_{ma x}}{B}} = \frac{{RTT}_{m i n , i}}{{RTT}_{ma x , i}} . \qquad ( 7 )$$

Based on the above observation embodiments of the invention can provide an adaptive strategy under which the provisioning of each TCP flow is estimated on-line and the backoff factor set such that the throughput on a per-flow basis is matched before and after backoff. In ideal circumstances this should ensure that the buffer just empties following congestion and the link remains operating at capacity. The parameters required for such an adaptive mechanism can be obtained at each flow by measuring the maximum and minimum round-trip time. Since it is known that:

$${RTT}_{m i n , i} = {T}_{di} , \\ {RTT}_{ma x , i} = \frac{{q}_{ma x}}{B} + {T}_{di} ,$$

then the multiplicative backoff factor βᵢ: that ensures efficient use of the link is:

$${β}_{i} = \frac{{RTT}_{m i n , i}}{{RTT}_{ma x , i}} .$$

Alternatively, this ratio can be expressed as:

$$\begin{matrix}{β}_{i} ( k + 1 ) = {β}_{i} ( k ) \frac{{B}_{m ax}^{i} ( k )}{{B}_{m i n}^{i} ( k )} & ( 8 ) \\ = \frac{{T}_{di}}{{T}_{di} + \frac{q}{B}} & ( 9 ) \\ = \frac{{RTT}_{m i n , i}}{{RTT}_{ma x , i}} & ( 10 )\end{matrix}$$

where βⁱₘₐₓ(k) is the throughput of flow i immediately before the kth congestion event, and βⁱₘᵢₙ(k) is the throughput of flow i immediately after the kth congestion event. This avoids the need to measure Rα_{max,i} directly. Note that it is, in many cases, important to maintain fairness: by setting

$${β}_{i} = \frac{{RTT}_{m i n , i}}{{RTT}_{ma x , i}}$$

a corresponding adjustment of αᵢ is required. Both network fairness and compatibility with TCP are ensured by adjusting αᵢ according to αᵢ=2(1−βᵢ).

In summary, the adaptive backoff mechanism operates at a source as follows:
1. Determine initial estimates of RTT_{min,i} and RTT_{max,i} by probing during the slow start phase;
2. Set the multiplicative backoff factor βᵢ as the ratio of RTT_{min,i} to RTT_{max,i};
3. Adjust the corresponding additive increase parameter αᵢ according to αᵢ=(1−βᵢ); and
4. Monitor continuously the relative values of RTT_{max,i} and RTT_{min,i} to check for dynamic changes in the link provisioning.

Note that the above strategy may be implemented by measuring the RTT values directly, or indirectly as indicated in equation 8.

The ratio

$$\frac{{RTT}_{m i n , i}}{{RTT}_{ma x , i}}$$

may approach unity on under-provisioned links. However values of βᵢ close to unity will give slow convergence after a disturbance (e.g. traffic joining or leaving the route associated with the link, see examples below). It follows that a further adaptive mechanism is desirable which continuously adjusts the trade-off between network responsiveness and efficient link utilization. This requires a network quantity that changes predictably during disturbances and that can be used to trigger an adaptive reset. One variable that does this is the minimum of the mean inter-packet time (IPT_{min,i}), where the mean is taken over a round-trip time period. Another variable is the mean throughput. The IPT_{min,i} is a measure of the link bandwidth allocated to a particular flow. This in turn is determined by the link service rate B (which is assumed to be constant), the number of flows and the distribution of bandwidth among the flows. Thus as new flows join, the IPT_{min,i} for an existing flow can be expected to increase. On the other hand, the value of IPT_{min,i} will decrease when the traffic decreases. Thus, by monitoring IPT_{min,i} for changes it is possible to detect points at which the flows need to be adjusted and reset βᵢ to some suitable low value for a time.

In summary, an adaptive reset algorithm embodying the invention can proceed as follows:
(i) Continually monitor the value of IPT_{min,i} or the mean throughput.
(ii) When the measured value of IPT_{min,i} or the mean throughput moves outside of a threshold band, reset the value of βᵢ to β_{reset,i}.
(iii) Once IPT_{min,i} or the mean throughput returns within the threshold band (e.g. after convergence to a new steady state, which might be calculated from β_{reset,i}), re-enable the adaptive backoff algorithm

$${β}_{i} = \frac{{RTT}_{m i n , i}}{{RTT}_{ma x , i}} .$$

The two adaptive mechanisms (backoff and reset) present in a particularly preferred embodiment of the invention are shown schematically in FIG. 6.

Note that as previously discussed, this strategy can be implemented indirectly using Bⁱₘₐₓ (k) as in Equation 8, above.

The adapted TCP protocol provides a method of congestion control in transmission of data in packets over a network link using a transport layer protocol, wherein: a) the number of unacknowledged packets in transit in the link is less than or equal to a congestion window value cwndᵢ for the ith flow; b) the value of cwndᵢ is varied according to an additive-increase multiplicative-decrease (AIMD) law having an increase parameter αᵢ, and the value of αᵢ is increased during each congestion epoch.

The method effectively operates in two modes during a congestion epoch. Initially, it operates in a low-speed mode that is compatible with conventional TCP. After the value of αᵢ is increased it operates in a high-speed mode in which it takes better advantage of a high-speed link than can conventional TCP. The initial compatibility with TCP ensures proper operation of the system in a network that includes both high-speed and low-speed data sources.

The value of αᵢ may increase at a fixed time after the start of each congestion epoch, for example as a fixed multiple of the round-trip time for a data packet to travel over the network link. As a development of this arrangement, the value of αᵢ may increases at a plurality of fixed times after the start of each congestion epoch. In this case, each fixed time may be calculated as a respective fixed multiple of the round-trip time for a data packet to travel over the network link.

Alternatively, the value of αᵢ may increase as a function of time from the start of a congestion epoch, for example, as a polynomial function of time from the start of a congestion epoch.

Most preferably, the value of αᵢ is unity at the start of each congestion epoch to ensure compatibility with standard TCP.

As a particular example, in a method embodying the invention, upon detection of network congestion during a kth congestion epoch at a time when the value of cwndᵢ is wᵢ(k), the value of cwndᵢ becomes βᵢwᵢ(k)−δ where δ=0 initially and δᵢ=βᵢ(αᵢ^{H}−αᵢ^{L}) after an increase in the value of αᵢ.

This adaptation of the standard TCP protocol also provides a method of transmitting data in packets over a network link and a networking component for transmitting data in packets over a network link that employ congestion control as defined above.

From another aspect, the adapted TCP protocol comprises a method of congestion control in transmission of data in packets over a network link using a transport layer protocol, wherein:
a) the number of unacknowledged packets in transit in the link is less than or equal to a congestion window value cwndᵢ for the tth flow;
b) the value of cwndᵢ is varied according to an additive-increase multiplicative-decrease (AIMD) law having a multiplicative decrease parameter βᵢ, and
c) the value of βᵢ is set as a function of one or more characteristics of one or more data flows carried over the network link.

This provides an adaptive backoff that can further enhance the effectiveness of congestion control by way of the invention.

In such examples, the value of βᵢ is typically set as a function of the round-trip time of data traversing the link. For example, in cases in which the link carries a plurality of data flows, there is a round-trip time RTTᵢ associated with the ith data flow sharing the link, the shortest round-trip time being designated RTT_{min,i} and the greatest round-trip time being designated RTT_{max,i}, the value of βᵢ may be set as

$${β}_{i} = \frac{{RTT}_{m i n , i}}{{RTT}_{ma x , i}} .$$

This may be on-going during transmission such that the values of RTT_{min,i} and RTT_{max,i} are monitored and the value of

$${β}_{i} = \frac{{RTT}_{m i n , i}}{{RTT}_{ma x , i}}$$

is re-evaluated periodically.

To ensure fairness of access, the additive-increase parameter αᵢ may be varied as a function of βᵢ. Of particular preference, and to ensure fair access to high-speed and conventional sources, αᵢ may be varied as αᵢ=2(1−βᵢ).

Advantageously, the value of round-trip times of one or more data flows carried over the network link are monitored periodically during transmission of data and the value of βᵢ is adjusted in accordance with updated round-trip values thereby determined.

The value of βᵢ may be set as a function of the mean inter-packet time of data flowing in the link or the mean throughput.

This adaptation of the TCP protocol also provides a method of congestion control in which the value of βᵢ is set by:
a) during data transmission, periodically monitoring the value of the mean inter-packet time IPTmin,i or throughput of the i'th flow;
b) upon the measured value of IPTmin,i moving outside of a threshold band, resetting the value of βᵢ to β_{breset,i} (typically 0.5); and
c) upon IPTmin,i or throughput returning within the threshold band, setting

$${β}_{i} = \frac{{RTT}_{m i n , i}}{{RTT}_{ma x} , i}$$

and periodically resetting βᵢ in response to changes in the value of RTTmin,1 or RTTmax,i.

It will be clear to a person skilled in the technology of computer networking that protocols embodying the invention can readily be implemented in a software component. For example, this can be done by modification of an existing implementation of the transmission control protocol (TCP). Networking components embodying the invention may implement variation in either or both of the values of αᵢ and βᵢ as described above. Such a component can form an addition to or a replacement of a transport layer networking component in an existing or in a new computer operating system.

### Modified Congestion Control

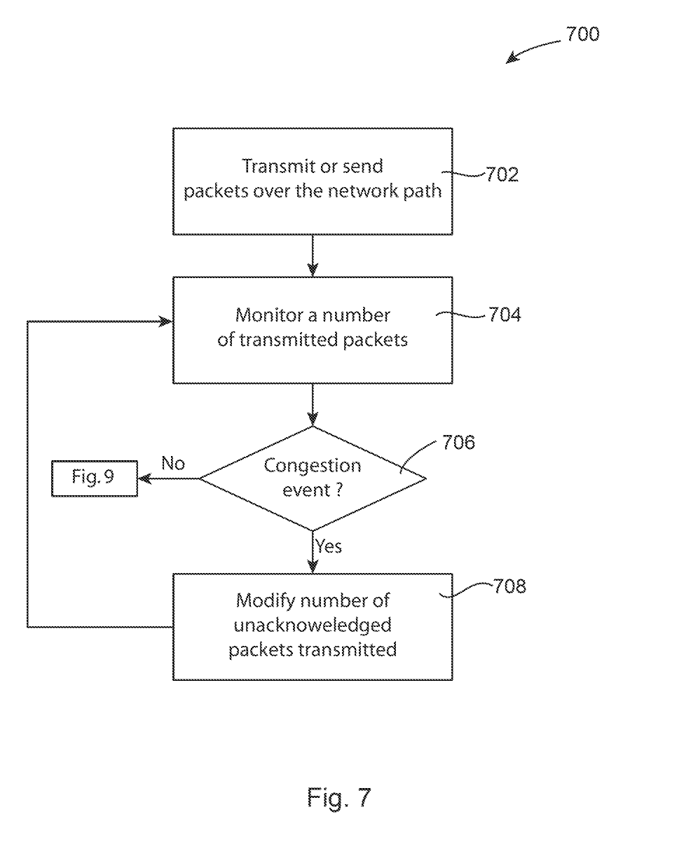

Embodiments of the invention will now be discussed with reference to FIGS. 7 to 11.

As in the standard and adapted TCP discussed above, a rate of packet transmission (a transmission or send rate) may be controlled by regulating the number of unacknowledged packets ‘in flight’, i.e. the number packets that have been transmitted by the transmitter but for which an acknowledgment ACK has not been received. The number of unacknowledged packets transmitted may be referred to as the congestion window cwnd. In this manner, available bandwidth can be used efficiently without degradation of performance caused by unacceptable delays or loss of packets.

FIG. 7 is a flow chart depicting an exemplary method 700 of modifying a rate of transmission of packets over a network path in accordance with an embodiment of the invention. The network path may be a path within any suitable type of network. For example, the network path may be a path in a wireless network.

The method 700 may be implemented in any suitable manner. For example, the method 700 may be implemented by the Adaptive Congestion Controller of FIG. 6, or by a processor comprised within, or operable in associated with said Adaptive Congestion Controller. In an exemplary embodiment, the method 700 is performed by, or in association with, a transmitter (or sender or source) of data packets.

In an exemplary embodiment, the method 700 is implemented as one or more of a part of a transport layer protocol; part of a network tunnel protocol; or part of a network proxy protocol. In particular, the method 700 may be implemented for transmission of packets over a lossy′ network path, i.e. a network path over which packets may be dropped or lost during transmission.

At step 702, a processor is operated to transmit packets over the network path. It will be appreciated that the packets may be transmitted by any suitable method in accordance with the network over which the packets are transmitted. This step will be discussed further with respect to FIG. 9.

At step 704, the processor is operated to monitor or observe a number of unacknowledged packets transmitted over the network path. An unacknowledged packet is a packet that has been transmitted over the network path, but in respect of which no acknowledgment or ‘ACK’ has yet been received.

Based on the observed number of unacknowledged packets, the processor is operated to determine whether or not a congestion event has occurred at step 706. If the processor determines that a congestion event has not occurred, processing may continue at step 902 of method 900, as described in more detail with respect to FIG. 9.

If, on the other hand, a congestion event is detected at step 708, the processor is operated to modify the number of unacknowledged packets that can be transmitted over the network by a multiplicative factor βᵢ.

A congestion event may be determined by any suitable means. For example, the processor may be operated to determine that a congestion event has occurred if one or more of the following situations is detected, or estimated to have occurred: a packet loss is detected; an estimated time for a packet to be transmitted over the network path is greater than a predefined threshold value; any other suitable congestion indicator is detected.

The multiplicative factor βᵢ is proportional to a ratio of a first time value that is indicative of a minimum time required for a packet to be transmitted over the network path to a second time value that is indicative of a current time required for a packet to be transmitted over the network path.

The first and second time values may be determined by any suitable means. For example, these values may be predefined values received and/or defined prior to transmission of the packets at step 702. Additionally or alternatively, the first and second time values may be determined and/or updated during performance of the method 700.

In this manner, the multiplicative backoff factor βᵢ adapts to each loss event. When a network path is under-utilized the current time for a packet to be transmitted over the network path (the second time value) is equal or close to the minimum time for a packet to be transmitted over the network path (the first time value). Accordingly, in this situation, the multiplicative factor βᵢ is unity and the number of packets transmitted over the network path is not decreased in response to packet loss.

Once the link starts to experience queuing delays, however, the current time for a packet to be transmitted over the network path will increase. The multiplicative factor βᵢ will therefore decrease resulting in a decrease in the number of unacknowledged packets that are transmitted over the network path. As the queue delay decreases, the current time for a packet to be transmitted over the network path decreases and the he multiplicative factor βᵢ once again increases towards unity. The performance improvements arising from the use of the modified multiplicative factor βᵢ when compared to known congestion control techniques can be seen from FIG. 11.

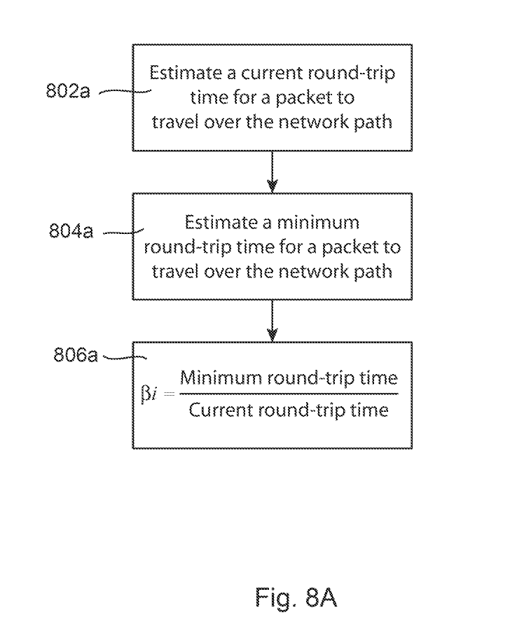

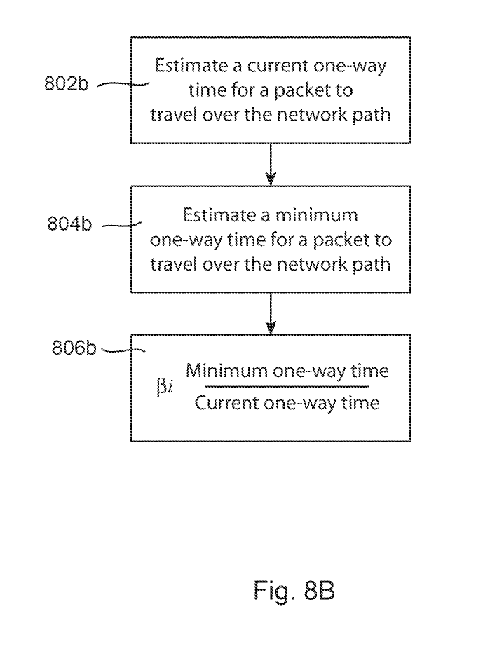

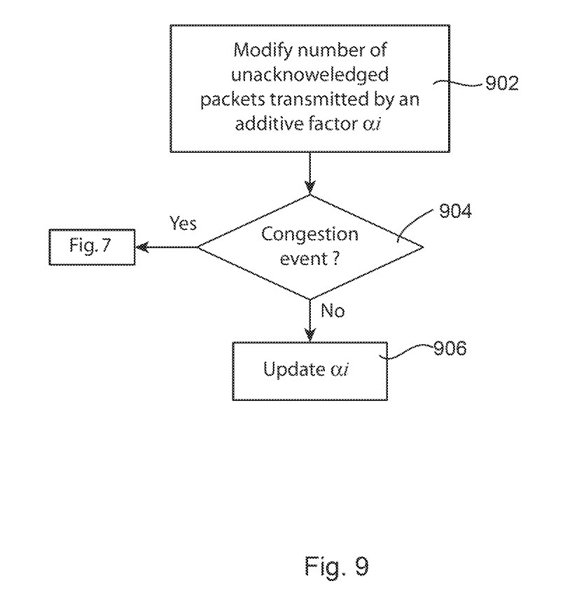

FIG. 8A depicts a method of determining the first and second time values according to an exemplary embodiment of the invention. At step 802a, the processor is operated to estimate a current (or recent) Round-Trip Time (R_{TT}) or delay for a packet transmitted over the network path. The R_{TT} can be estimated by any suitable means. For example, a timestamp can be attached to and/or associated with one or more of the transmitted packets, the timestamp being indicative of a time at which the relevant packet was transmitted. An estimate of the R_{TT} can then be obtained by comparing the transmission time of the packet to a time at which an acknowledgement of receipt was received in respect of the packet.

In an exemplary embodiment, step 802a is repeated to observe a respective measurement of the Round-Trip Time R_{TTi}, i=1, . . . , N, for N packets. The estimated value of the Round-Trip Time R_{TT} is then determined based on the plurality of observed values. For example, R_{TT} may be determined to be the mean, mode, median, maximum, minimum, or any other suitable value derived from, or in accordance with, the plurality of observed Round-Trip time values R_{TTi}.

At step 804a, the processor is operated to estimate a minimum Round-Trip time R_{TTmin} for a packet transmitted over the network path. The minimum Round-Trip time may be estimated and/or determined in any suitable manner. For example, as discussed above, the transmitted packets may be time-stamped and the processor may be operated to store a minimum observed Round-Trip time value in a memory accessible to the processor. In this manner, R_{TTmin} is an estimate of the round-trip path delay when there are no queue backlogs along the network path.

At step 806a, the processor is operated to determine the multiplicative factor βᵢ to be proportional to a ratio of the current estimated Round-Trip time value R_{TT} to the minimum Round-Trip time value R_{TTmin}.

FIG. 8b depicts a further method 800b of determining the second time value in accordance with an embodiment of the invention. The method 800b may be performed as an alternative to, or in addition to, the method 800a. In particular, where there is queuing on the reverse path (i.e. the path over which an acknowledgment of receipt is transmitted by the receiver), the method 800b may be preferred to the method 800a.

At step 802b, the processor is operated to estimate a One-Way path delay for a packet transmitted across the network path. The One-Way path delay is the time taken to transmit a packet from sender to receiver. The One-Way path delay may be determined or estimate using any suitable means. For example, the One-Way path delay may be estimated in the manner discussed above in relation to estimation of the Round-Trip at step 802a. However, it will be appreciated that in the method 800b, the observed time values will be the time taken for a transmitted packet to reach a receiver (not the time for the transmitter to receive an acknowledgement).

At step 804b, the processor is operated to estimate a minimum One-Way path delay or delay when there are no queue backlogs along the path. As discussed above with respect to step 804a, the minimum One-Way path delay may be estimated by any suitable means. For example, the minimum One-Way path delay may be the minimum observed One-Way path delay.

At step 806b, the processor is operated to determine the multiplicative factor βᵢ to be proportional to a ratio of the current estimated One-Way path delay to the minimum One-Way path delay.

Irrespective of how the first and second time values are estimated, these values will preferably be updated during implementation of the method. In this manner, the method can adapt to changes in the path propagation delay over time (due to routing changes, adaptive scheduling at the wireless link etc.).

As discussed above in relation to step 706, if the processor determines that a congestion event has not occurred, processing continues at step 902 of the method 900 at which the number of unacknowledged packets transmitted (i.e. the number of packets transmitted over the network path, or ‘in flight’, for which an acknowledgement has not been received.) is modified by an additive factor αᵢ.

The additive factor αᵢ, may be any suitable value for increasing the number of unacknowledged packets transmitted when no congestion or loss is detected. Prior to transmission of the packets at block 702, αᵢ may be set to an initial value, for example, 1 or any other suitable initial value.

At step 904, the processor is operated to determine whether there has been a congestion event. This step may be performed in the same manner as discussed in relation to step 706 of FIG. 7. In an exemplary embodiment, the processor is operated to determine whether a congestion event has occurred by monitoring a number of unacknowledged packets that have been transmitted over the network path. A congestion event may then be determined if the number of unacknowledged packets transmitted is greater than a threshold number. Additionally or alternatively, the processor may determine that a congestion event has occurred based on any other suitable indicator of congestion and/or loss.

If a congestion event is determined at step 904 processing continues at step 708 of FIG. 7, at which the number of unacknowledged packets transmitted is modified by the multiplicative factor βᵢ.

Alternatively, if no congestion event is determined at step 904, the processor is operated to update or modify the additive factor αᵢ. In the exemplary embodiment of FIG. 9, the additive factor αᵢ, is determined or updated in accordance with an elapsed period of time since a congestion event was last detected. This elapsed period of time is often referred to as the ‘congestion epoch’.

It will be appreciated that if the congestion epoch is short, a congestion event has occurred recently and accordingly, it may not be desirable to increase the number of unacknowledged packets transmitted by a large amount. Accordingly, in an exemplary embodiment, if the congestion epoch is less than a predefined value, the additive factor αᵢ, is determined to be equal to unity.

If the congestion epoch is determined to be long (e.g. long relative to recent and/or usual congestion epoch values), then no congestion event has been occurred for a significant period. In this situation, it may be desirable to significantly increase the number of packets transmitted in order to optimally use the available bandwidth. In an exemplary embodiment, the processor is operated to increase the additive factor αᵢ, as a function of the congestion epoch.

In an exemplary embodiment, the processor is operated to modify the additive factor αᵢ at step 908, at intervals during a period in which no congestion is detected. For example, the processor may be operated to perform step 908 at predefined intervals during a period in which no congestion event has been detected. The predefined intervals may be regular or irregular intervals during the congestion epoch.

### Coded TCP—CTCP

Known error-correction coding schemes for packet erasure channels are largely either open-loop in nature (i.e. forward error correction) or are based on an assumption of near instantaneous feedback from the receiver (akin to Automatic Repeat Request (ARQ)). It is desirable to develop a coding scheme that makes efficient use of delayed feedback to achieve high throughput and low decoding delay.

Before discussing embodiments of the invention in detail, an overview of error correction coding is provided. The sender or transmitter of the packets initially segments data to be transmitted (e.g. a data stream, a file etc.) into a series of blocks containing blksize packets, where each packet is assumed to be of fixed length. If the remainder of the data to be transmitted is not large enough to form a complete packet, the packet may be padded with zeros to ensure that all packets are of the same length. A block need not be completely full, i.e. a block may have fewer than blksize packets. However each blockᵢ should be full before a subsequent blockᵢ₊₁ is initialized. After transmitting an initial block of packets, the size of the block may be adapted in light of feedback from the receiver.

The sender buffers a number blocks, denoted numblks, and the value of numblks should be conveyed to the receiver. The value of numblks may be negotiated at initialization between the sender and the receiver, as numblks directly affects the memory usage on both ends. We denote the smallest block in memory to be currblk. Note that this does not mean that sender may send numblks×blksize amount of data at any time.

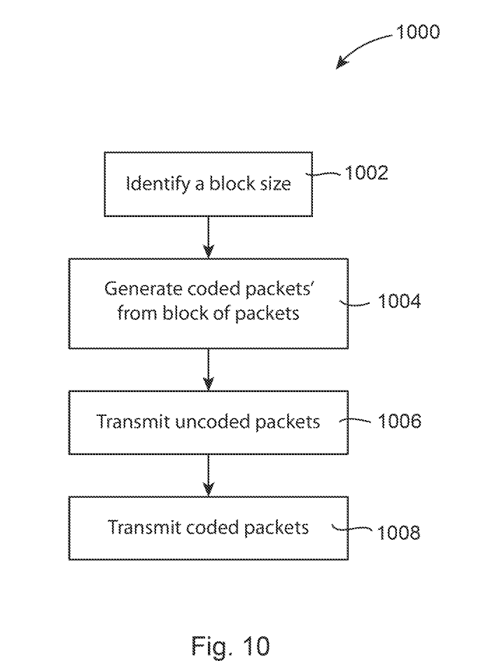

The sender is allowed to transmit packets only if the congestion control mechanism allows it to; however, whenever it is allowed to transmit, the sender may choose to transmit a packet from any one of the blocks in memory, i.e. blocks currblk, currblk+1, . . . , currblk+numblks−1. The payload of the transmitted packet may be coded or encoded (or unencoded). Coding of the packets is discussed in more detail below with respect to FIG. 10.

The sender may include one or more of the following in each packet: (i) the block number, (ii) a seed for a pseudo-random number generator which allows the receiver to generate the coding coefficients, (iii) the sequence number, denoted seqno, and (iv) the (coded or uncoded) payload.

The sequence number for CTCP differs from that of standard TCP. In particular, for standard TCP, a sequence number indicates a specific data byte; for CTCP, a sequence number indicates that a packet is the seqno-th packet transmitted by the sender, thus, is not tied to a byte in the file.

The receiver sends acknowledgments (ACKs) for the packets it receives. In the ACK, the receiver may indicate one or more of: (i) the smallest undecoded block ack_currblk, (ii) the number of degrees of freedom (dofs) denoted ack_currdof it has received for the current block denoted ack_currblk, and (iii) the sequence number, denoted ack_seqno of the packet it is acknowledging.

The sender (or transmitter or source) may then adapt or modify its behaviour based on the information included in the ACK response. For example, the sender may modify the number of packets that are transmitted in a block. Additionally, or alternatively, as discussed above in relation to FIGS. 7 to 9, the sender may modify the rate of transmission or the number of unacknowledged packets that are transmitted over the network path. In this manner, in CTCP the receiver is primarily concerned with decoding and delivery of the received data to the relevant application.

FIG. 10 depicts a flow diagram of a method of performing error correction coding in accordance with an embodiment of the invention. The error correction coding is performed prior to, or during, transmission of the packets at step 702 of FIG. 7.

At step 1002, the processor is operated to identify a suitable block size or number of packets over (across, or based on) which the coding operations are to be performed. It will be appreciated that setting the initial blocks size to unity (i.e. one packet) leads to operations similar to that of traditional or standard TCP. It will be appreciated that selection of a very large block size, on the other hand, leads to increased encoding/decoding complexity and delay.

In an exemplary embodiment, the block size is determined in accordance with characteristics of the network path. For example, the blocks size can be selected to be equal or similar to the product of the bandwidth and the delay of the network. In this manner, feedback (e.g. acknowledgements) from the receiver in relation to the first packets of the block will arrive at the sender around the time that the sender completes transmission of the packets in the block. The feedback can then be used to adapt the next block size used. In this manner, the process can adapt to changing characteristics of the network.

At step 1002, the processor is also operated to identify a coding field. It will be appreciated that any suitable coding field may be used. The coding field selected affects performance since a higher field size leads to a higher probability of generating independent degrees of freedom (dofs), resulting in increased efficient. However, this increase in efficiency comes at the cost of coding and decoding complexity. In an exemplary embodiment of the invention, a field of F₂₅₆ is used (i.e. each coefficient is a single byte).

It will be appreciated that in some embodiments the block size and/or coding field may be predefined values received prior to implementation of the method 700.

At step 1004, the processor is operated to generate coded packets from the packets in the block. The coded packets may be generated by any suitable process. In an exemplary embodiment, the coded packets may be generated by randomly coding some or all of the packets in the block. Advantageously, this type of coding provides a high probability that each coded packet will correct for any single erasure (i.e. loss of any packet) in the block.

At step 1006, the processor is operated to transmit the uncoiled packets in the block and at step 1008, the processor is operated to transmit the one or more coded packets.

It will be appreciated that steps 1004 to 1008 may be combined. Additionally or alternatively, these steps may be performed simultaneously.

Responsive to receiving the block of packets, the receiver decodes the packets and, if necessary, performs error correction. The decoding and error correction may be performed by any suitable means.

In an exemplary embodiment, for each block, denoted blkno, comprising blksize packets (i.e. block size is blksize), the receiver may operate a processor to initialize a blksize×blksize matrix C_{blkno} for the coding coefficients and a corresponding payload structure P_{blkno}. Responsive to determining that a packet from the block blkno has been received, the processor is operated to determine (or extract) the coding coefficients and the coded payload of the packet. The receiver then operates the processor to insert (or store) the extracted coding coefficient in the matrix C_{blkno} and the extracted payload of the packet in P_{blkno}.

The receiver then operates the processor to use Gaussian elimination to determine whether a received packet is linearly independent to previously received packets. Responsive to determining that the received packet is linearly independent to the previously received packets, the processor is operated to increment a value of a counter ack_currdof.

The processor then compares the value of the counter ack_currdof to the block size value blksize. If the counter ack_currdof is equal to the block size blksize, the receiver determines that the packets of the block of been successfully received since blksize linearly independent messages have been received. Responsive to this determination, the processor is operated to send an acknowledgement message to the sender of the packets indicating that all the packets have been successfully received. The processor then updates a block counter, ack_currblk, to reflect that a further block of packets has been successfully received.

Alternatively, if the processor determines that the received packet is not linearly independent from previously received packets, the receiver transmits an acknowledgement message ACK in respect of the particular packet that has been received. However, since the packet is not linearly independent from the previously received packets, the receiver does not operate the processor to update the counter ack_currdof. Instead, the receiver proceeds to repeat the process with the next packet received.

Once blksize linearly independent packets have been received for a block, the receiver can decode all packets within the block. Hence, even in situations where some of the packets are lost or dropped during transmission, the receiver can use the encoded packet to correct for any loss or erasures without requiring re-transmission of the lost packet. It will be clear to a person skilled in the technology of computer networking that any other suitable method of coding and/or decoding of the packets may be implemented without departing from the spirit and scope of the invention.

The implementation of error-correction coding, for example in the manner described in relation to FIG. 10, allows for recovery of lost packets or information without requiring the packets to be re-transmitted and without the need for cross-layer techniques such as explicit feedback from the link layer or other techniques such as explicit congestion notification. In this manner, error-correction coding effectively masks or hides packet loss over the network path. Since standard TCP uses such packet loss as an indication of congestion, standard TCP is not suited for congestion control in these situations.

However, the use of modified multiplicative factor (or backoff factor) βᵢ at step 708 of FIG. 7 enables the congestion control methods described above in relation to FIGS. 7 to 9 to operate efficiently in this situation. Furthermore, as discussed above, the modified multiplicative factor (or backoff factor) βᵢ reverts to known AIMD operation in networks where packet losses primarily occur due to congestion (or queue overflow), e.g. in wired networks.

It will be clear to a person skilled in the technology of computer networking that protocols embodying the invention can readily be implemented in a software component. For example, this can be done by modification of an existing implementation of the transmission control protocol (TCP). Networking components embodying the invention may implement variation in either or both of the values of αᵢ and βᵢ as described above. Such a component can form an addition to or a replacement of a transport layer networking component in an existing or in a new computer operating system.

1. A method of modifying transmission of packets over a network path, the method comprising operating a processor to:
transmit packets over the network path;
determine, based on a number of unacknowledged packets transmitted over the network path, whether a congestion event has occurred, wherein an unacknowledged packet is a transmitted packet for which no acknowledgement has been received; and
responsive to detecting a congestion event, operating a processor to modify the number of unacknowledged packets transmitted by a multiplicative factor βᵢ, wherein the multiplicative factor βᵢ is proportional to a ratio of a first time value to a second time value, the first time value being indicative of a minimum time required for a packet to be transmitted over the network path and the second time value being indicative of a current time required for a packet to be transmitted over the network path.

2. The method of claim 1, wherein responsive to determining that a congestion event has not occurred, the method further comprises operating a processor to:
modify the number of unacknowledged packets transmitted over the network path by an additive factor αᵢ.

3. The method of claim 2, wherein responsive to determining that a congestion event has not occurred, the method further comprises operating a processor to determine an elapsed period of time since detection of a congestion event.

4. The method of claim 3, further comprising operating a processor to determine the additive factor αᵢ in accordance with the elapsed period of time since detection of a congestion event.

5. The method of claim 4, wherein when the elapsed period of time since detection of a congestion event is less than a threshold value, the additive factor αᵢ is equal to unity.

6. The method of claim 5, wherein operating a processor to determine the additive factor αᵢ in accordance with the elapsed period of time since detection of a congestion event comprises operating the processor to increase the additive factor αᵢ as a function of the congestion epoch timer.

7. The method of claim 5, wherein operating a processor to determine the additive factor αᵢ in accordance with the elapsed period of time since detection of a congestion event comprises operating the processor to increase the additive factor αᵢ at intervals during a period in which the congestion epoch timer is greater than a threshold value.

8. The method of claim 1, wherein the processor is operated to detect a congestion event if one or more of:
(i) a packet loss is detected; and
(ii) an estimated time for a packet to be transmitted over the network path is greater than a predefined threshold value.

9. The method of claim 1, further comprising operating a processor to:
estimate, at predefined intervals, a round-trip delay between a time of transmitting a packet over the network path and a time of receiving an acknowledgement that the packet has been received; and
set the second time value to the estimated round-trip delay.

10. The method of claim 9, wherein the first time value is an estimate of a minimum round-trip delay between a time of transmitting a packet over the network path and a time of receiving an acknowledgement that the packet has been received; and
the multiplicative factor βᵢ is equal to a ratio of the first time value to the second time value.

11. The method of claim 1, further comprising operating a processor to:
estimate, at predefined intervals, a one-way delay time between a time at which the packet is transmitted over the network path and a time at which the packet is received by a receiver; and
set the second time value to the estimated one-way delay time.

12. The method of claim 11, wherein the first time value is an estimate of a minimum one-way delay time between a time at which a packet is transmitted over the network path and a time at which the packet is received by a receiver; and
the multiplicative factor βᵢ is equal to a ratio of the first time value to the second time value.

13. The method of claim 1, wherein the second value is an exponentially weighted moving average of estimated packet delays.

14. The method of claim 1, wherein the network is a wireless network.

15. The method of claim 1, wherein the method is implemented as part of a transport layer protocol.

16. The method of claim 1, wherein the method is implemented as part of a network tunnel protocol.

17. The method of claim 1, wherein the method is implemented as part of a network proxy protocol.

18. The method of claim 1, wherein operating a processor to transmit packets over the network path comprises operating the processor to:
encode the packets using error correction coding; and
transmit the encoded packets.

19. The method of claim 18, wherein operating a processor to encode the packets using error coding and to transmit the encoded packets comprises operating the processor to:
transmit a number of information packets;
generate an encoded packet based on the information packets; and
transmit the encoded packet.

20. The method of claim 19, wherein operating a processor to generate the encoded packet comprises operating a processor to generate the encoded packet using Reed-Solomon encoding.

21. The method of claim 19, wherein operating a processor to generate the encoded packet comprises operating a processor to generate the encoded packet using linear encoding.

22. The method of claim 21, further comprising operating a processor at a receiver to:
receive the encoded packets; and
decode the received packets using Gaussian elimination decoding.

23. (canceled)

24. (canceled)

25. (canceled)

26. A transmitter for sending packets over a network path, wherein the transmitter comprises processing circuitry configured to:
transmit packets over the network path;
determine, based on a number of unacknowledged packets transmitted over the network path, whether a congestion event has occurred, wherein an unacknowledged packet is a transmitted packet for which no acknowledgement has been received; and
responsive to detecting a congestion event, operating a processor to modify the number of unacknowledged packets transmitted by a multiplicative factor βᵢ, wherein the multiplicative factor βᵢ is proportional to a ratio of a first time value to a second time value, the first time value being indicative of a minimum time required for a packet to be transmitted over the network path and the second time value being indicative of a current time required for a packet to be transmitted over the network path.

27. (canceled)

28. (canceled)

29. (canceled)

30. (canceled)

31. (canceled)

32. (canceled)

33. (canceled)

34. (canceled)

35. (canceled)

36. (canceled)

37. A non-transitory computer-readable medium comprising instructions which when executed cause a processor to:
transmit packets over the network path;
determine, based on a number of unacknowledged packets transmitted over the network path, whether a congestion event has occurred, wherein an unacknowledged packet is a transmitted packet for which no acknowledgement has been received; and
responsive to detecting a congestion event, operating a processor to modify the number of unacknowledged packets transmitted by a multiplicative factor βᵢ, wherein the multiplicative factor βᵢ is proportional to a ratio of a first time value to a second time value, the first time value being indicative of a minimum time required for a packet to be transmitted over the network path and the second time value being indicative of a current time required for a packet to be transmitted over the network path.
